(19) United States
(12) Patent Application Publication
(10) Pub. No.: US 2012/0188486 A1
(43) Pub. Date: Jul. 26, 2012

(54) LIQUID CRYSTAL DISPLAY DEVICE

(75) Inventors: Masashi BABA, Chiba (JP); Nagatoshi KURAHASHI, Chiba (JP); Katsunori KANNO, Chiba (JP)

(73) Assignee: PANASONIC LIQUID CRYSTAL DISPLAY CO., LTD., Himeji-shi (JP)

(21) Appl. No.: 13/356,239

(22) Filed: Jan. 23, 2012

(30) Foreign Application Priority Data
Jan. 24, 2011 (JP) 2011-012383

(51) Int. Cl. G02F 1/1335

(52) U.S. Cl. 349/67

(57) ABSTRACT

In a liquid crystal display device including a backlight unit that irradiates the entire image formation region with light from light emitting diodes disposed in a concentrated manner, in order to efficiently diffuse heat generated from the light emitting diodes, provided is a liquid crystal display device (1), including: a liquid crystal panel (3); and a backlight unit (10) including in order from a front surface side: a reflection sheet (6), which is disposed on a rear surface side of the liquid crystal panel (3) and is curved so as to have a concave front surface; a light emitting diode substrate (7) on which a plurality of light emitting diodes are disposed along a longitudinal direction; and a radiator plate (8), in which a length of the radiator plate (8) in a width direction is larger than a length of the light emitting diode substrate (7) in the width direction.

### CROSS-REFERENCE TO RELATED APPLICATION

The present application claims priority from Japanese application JP 2011-012383 filed on Jan. 24, 2011, the content of which is hereby incorporated by reference into this application.

### BACKGROUND OF THE INVENTION

1. Field of the Invention

The present invention relates to a liquid crystal display device.

2. Description of the Related Art

JP 2007-286627 A discloses a liquid crystal display device including a direct type back light unit. In the liquid crystal display device, a plurality of light emitting diodes are used as light sources of the backlight unit. The light emitting diodes are disposed in matrix across an entire region of the backlight unit.

In the liquid crystal display device described in JP 2007-286627 A, the light emitting diodes are disposed across the entire region of the backlight unit, and hence the size of a substrate on which a large number of light emitting diodes are disposed needs to be large enough to cover the entire region of the backlight unit. This increases cost for preparing a large number of light emitting diodes as well as a material cost of the substrate on which the light emitting diodes are to be disposed.

To address the problem, it is conceivable to dispose the light emitting diodes in a concentrated manner in a region where the backlight unit is positioned, for example, in the vicinity of the center of the backlight unit in the short side direction, along the long side direction of the backlight unit so that light beams emitted from the light emitting diodes are reflected and diffused by an appropriate reflection sheet so as to irradiate an entire image formation region.

In such structure, however, the light emitting diodes are dispose at high density and the entire image formation region is irradiated by a small number of the light emitting diodes, and hence light intensity per light emitting diode increases. It is therefore expected that the light emitting diodes and their vicinities experience high temperature due to heat generated from the light emitting diodes, resulting in a fear of lowered light emission efficiency, degradation of the light emitting diodes, and distortion and breakage of the liquid crystal display device.

### SUMMARY OF THE INVENTION

The present invention has been made in view of the above-mentioned circumstances, and has an object of diffusing heat generated from light emitting diodes efficiently in a liquid crystal display device including a backlight unit that irradiates an entire image formation region with light from the light emitting diodes that are disposed in a concentrated manner.

Representative aspects of the invention disclosed herein are briefly outlined as follows.

(1) There is provided a liquid crystal display device, including: a liquid crystal panel; and a backlight unit including in order from the liquid crystal panel side: a reflection sheet, which is disposed on a rear surface side of the liquid crystal panel and is curved so as to have a concave surface facing the liquid crystal panel; a light emitting diode substrate on which a plurality of light emitting diodes are disposed along a longitudinal direction; and a metal plate to which the light emitting diode substrate is fixed, in which a length of the metal plate in a width direction is larger than a length of the light emitting diode substrate in the width direction.

(2) In the liquid crystal display device according to the above-mentioned item (1), the metal plate includes, in a front surface thereof, a light emitting diode substrate receiving portion for receiving the light emitting diode substrate.

(3) In the liquid crystal display device according to the above-mentioned item (1) or (2), the reflection sheet is fixed to the metal plate by a reflection sheet fixture in a region on an outer side of the light emitting diode substrate in the width direction.

(4) In the liquid crystal display device according to the above-mentioned item (3), the metal plate includes, in a rear surface thereof, a reflection sheet fixture receiving portion for receiving a portion of the reflection sheet fixture exposed to the rear surface side of the metal plate.

(5) In the liquid crystal display device according to any one of the above-mentioned items (1) to (4), the light emitting diode substrate is fixed to the metal plate by a light emitting diode substrate fixture, and the light emitting diode substrate includes a light emitting diode substrate fixture receiving portion for receiving a portion of the light emitting diode substrate fixture exposed to a front surface side of the light emitting diode substrate.

(6) In the liquid crystal display device according to any one of the above-mentioned items (1) to (5), the metal plate is fixed to a housing for receiving the liquid crystal panel and the backlight unit by a metal plate fixture, and the metal plate includes, in a front surface thereof, a metal plate fixture receiving portion for receiving a portion of the metal plate fixture exposed to the front surface side of the metal plate.

(7) In the liquid crystal display device according to the above-mentioned item (3) or (4), a center position of the reflection sheet fixture in the longitudinal direction is in a range between two of the plurality of light emitting diodes in the longitudinal direction that are positioned close to the reflection sheet fixture.

(8) In the liquid crystal display device according to the above-mentioned item (7), the center position of the reflection sheet fixture is disposed on a perpendicular bisector to a segment connecting centers of the two of the plurality of light emitting diodes that are positioned close to the reflection sheet fixture.

According to the above-mentioned invention disclosed herein, it is possible to diffuse heat generated from the light emitting diodes efficiently in the liquid crystal display device including the backlight unit that irradiates the entire image formation region with light from the light emitting diodes that are disposed in a concentrated manner.

### BRIEF DESCRIPTION OF THE DRAWINGS

In the accompanying drawings:

FIG. 1 is an exploded perspective view of a liquid crystal display device according to an exemplary embodiment of the present invention;

FIG. 2 is a schematic cross-sectional view of the liquid crystal display device taken along the line II-II of FIG. 1;

FIG. 3 is a diagram illustrating a configuration of the liquid crystal display device;

FIG. 4 illustrates a circuit diagram of one pixel formed in a liquid crystal panel;

FIG. 5 is a view illustrating a reflection sheet, a light emitting diode substrate, and a radiator plate of the liquid crystal display device as viewed from the front surface side;

FIG. 6 is a partial enlarged cross-sectional view taken along the line VI-VI of FIG. 5;

FIG. 7 is a partial enlarged cross-sectional view taken along the line VII-VII of FIG. 5;

FIG. 8 is a partial enlarged cross-sectional view taken along the line VIII-VIII of FIG. 5; and

FIG. 9 is a view illustrating a positional relation between light emitting diodes and a reflection sheet fixture in a region encircled by C of FIG. 5.

### DETAILED DESCRIPTION OF THE INVENTION

Hereinafter, an exemplary embodiment of the present invention is described with reference to the accompanying drawings.

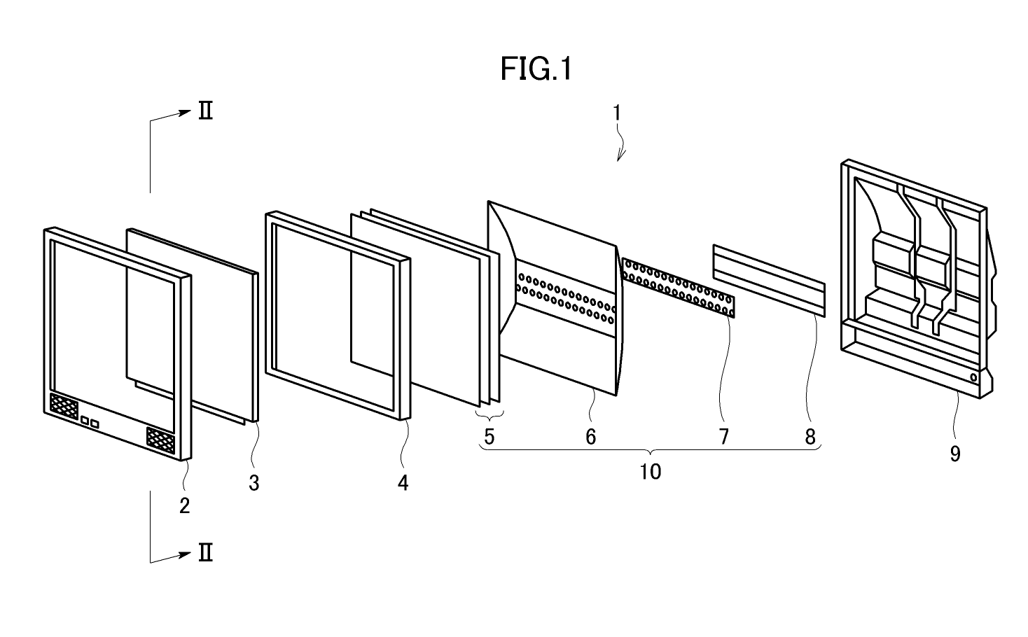

FIG. 1 is an exploded perspective view of a liquid crystal display device 1 according to this embodiment. As illustrated in FIG. 1, the liquid crystal display device 1 is assembled by arranging, in order from the front side, an upper frame 2, a liquid crystal panel 3, an intermediate frame 4, an optical sheet group 5, a reflection sheet 6, a light emitting diode substrate 7, a radiator plate 8, and a lower frame 9. Note that, the optical sheet group 5, the reflection sheet 6, the light emitting diode substrate 7, and the radiator plate 8 together constitute a backlight unit 10 that functions as a planar light source for illuminating the liquid crystal panel 3 from the rear surface side thereof. FIG. 1 illustrates only structural components of the liquid crystal display device 1 and omits other components, such as a control board and a speaker.

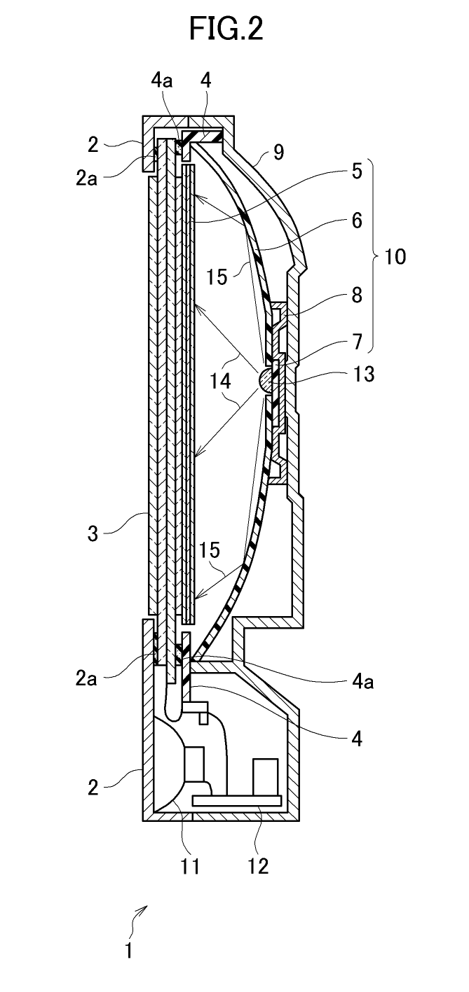

FIG. 2 is a schematic cross-sectional view of the liquid crystal display device 1 taken along the line II-II of FIG. 1. FIG. 2 illustrates a schematic cross-section of the assembled liquid crystal display device 1. As illustrated in FIG. 2, the liquid crystal display device 1 is structured to store the liquid crystal panel 3 and the backlight unit 10 in an outer frame formed of the upper frame 2 and the lower frame 9. The intermediate frame 4 is provided between the liquid crystal panel 3 and the backlight unit 10 so that the liquid crystal panel 3 and the backlight unit 10 are retained independently. The left side in FIG. 2 is the side where a user observes an image, which is hereinafter referred to as front side, and the surface facing the front side is referred to as front surface. The opposite side of the front side is referred to as rear surface side, and the surface facing the rear surface side is referred to as rear surface.

Note that, the liquid crystal display device 1 exemplified in this embodiment is a television set. Therefore, the liquid crystal display device 1 includes components for functioning as a television set, such as a speaker 11 illustrated in FIG. 2. Further, a control board 12 illustrated in FIG. 2 includes a power supply, a control circuit for the liquid crystal panel 3, and a control circuit for the backlight unit 10, as well as a circuit such as a tuner for receiving television broadcast. Note that, the liquid crystal display device 1 is not necessarily a television set, and may be a computer monitor, for example. In this case, the liquid crystal display device 1 may omit the components for functioning as a television set.

The upper frame 2 and the lower frame 9 constitute a housing for storing the liquid crystal panel 3 and the backlight unit 10, and it is preferred that the upper frame 2 and the lower frame 9 be formed of a lightweight material having high rigidity. Examples of the material that maybe used for the upper frame 2 and the lower frame 9 are metals, such as a steel plate, an aluminum alloy, and a magnesium alloy, FRP, and various kinds of synthetic resins. It is particularly preferred that the lower frame 9 be formed of a material having high heat conductivity in order to dissipate the heat generated due to light emission of the light emitting diodes efficiently, which is conducted from the light emitting diode substrate 7 via the radiator plate 8. In this embodiment, a steel plate is used. The material of the upper frame 2 may be the same as that of the lower frame 9 or may be different, and can be determined as appropriate considering the size, intended use, appearance, weight, and other factors of the liquid crystal display device 1. A buffer 2a is provided on the surface of the upper frame 2 facing the liquid crystal panel 3, so as to mitigate the shock occurring when the liquid crystal panel 3 swings due to vibration or the like and comes in contact with the upper frame 2. As the buffer 2a, an appropriate rubber, resin, sponge, or the like is used. It is to be understood that the support and buffer structure of the liquid crystal panel 3 described herein is an example.

The intermediate frame 4 is a member that retains the liquid crystal panel 3 and the backlight unit 10 independently in a separate manner. On the front surface of the intermediate frame 4, a buffer 4a is provided so as to mitigate the shock occurring when the liquid crystal panel 3 swings and comes in contact with the intermediate frame 4. As the buffer 4a, an appropriate rubber, resin, sponge, or the like is used. Note that, the structure of the intermediate frame 4 described herein is an example. The intermediate frame 4 may employ any structure that appropriately supports the liquid crystal panel 3 and the backlight unit 10, and may be omitted as occasion demands.

The material of the intermediate frame 4 is not particularly limited, either, but it is preferred to use a synthetic resin in terms of moldability and cost. In this embodiment, polycarbonate is used in terms of strength, but the material is not always limited thereto. As in fiber reinforced plastic (FRP), a reinforcing material may be mixed into a synthetic resin. It is also preferred that the intermediate frame 4 have light blocking effect and therefore be in black or dark color. The coloring of the intermediate frame 4 may be attained by a black or dark color material itself or by coating the surface of the intermediate frame 4. In this embodiment, the intermediate frame 4 is obtained by molding polycarbonate that is colored in black or dark color.

The backlight unit 10 includes the optical sheet group 5, the reflection sheet 6, the light emitting diode substrate 7, and the radiator plate 8. The light emitting diode substrate 7 of this embodiment is an elongated substrate on which a plurality of light emitting diodes 13 are mounted in line, and is provided so that a longitudinal direction of the light emitting diode substrate 7 is aligned with a longitudinal direction of the liquid crystal display device 1. The light emitting diode substrate 7 is fixed to the radiator plate 8. The reflection sheet 6 is a member for reflecting light from the light emitting diodes 13 to irradiate the rear surface of the liquid crystal panel 3 with light uniformly. The reflection sheet 6 has a curved cross-section as illustrated in FIG. 2. With such shape, light beams from the light emitting diodes 13 enter the optical sheet group 5 directly as indicated by arrows 14 of FIG. 2 or enter the optical sheet group 5 after reflected by the reflection sheet 6 as indicated by arrows 15 of FIG. 2.

The reflection sheet 6 and the optical sheet group 5 each have the size corresponding to the liquid crystal panel 3. Therefore, the liquid crystal panel 3 is illuminated with light uniformly from the rear surface side thereof. Here, the light emitting diode 13 includes a light emitting diode element and a lens which is disposed on the front surface side of the light emitting diode element. The light emitting diode element of this embodiment is a so-called light emitting diode package in which a light emitting diode chip is sealed with a sealing resin, and is mounted onto the light emitting diode substrate 7. However, this is not a limitation, and as another example, a light emitting diode chip may be formed directly on the light emitting diode substrate 7. The lens is an optical component for diffusing light beams emitted from the light emitting diode 13 so as to obtain illumination with uniform brightness over a display region of the liquid crystal panel 3.

The reflection sheet 6 has the size corresponding to the liquid crystal panel 3 as described above, and has a curved shape to be recessed as viewed from the front surface side. The reflection sheet 6 is provided with holes at positions at which the light emitting diodes 13 are disposed, so as to expose the light emitting diodes 13 to the front surface side of the reflection sheet 6. The material of the reflection sheet 6 is not particularly limited, and a white reflection sheet using a PET resin or the like or a mirror finish reflection sheet maybe used. In this embodiment, a white reflection sheet is used. The optical sheet group 5 is a plurality of optical films including a diffusion sheet for diffusing light entering from the light emitting diodes 13, a prism sheet for refracting light beams toward the front surface side, and the like.

The light emitting diode substrate 7 is an elongated substrate on which the plurality of light emitting diodes 13 are mounted. The plurality of light emitting diodes 13 are disposed along one direction, here, a direction parallel to the long sides of the liquid crystal display device 1. Note that, how to array the light emitting diodes 13 is not particularly limited, but in this embodiment, the light emitting diodes 13 are disposed in two rows in a staggered manner. The details are described later. As to the size of the light emitting diode substrate 7, the length in the longitudinal direction thereof is slightly shorter than the length of the liquid crystal panel 3 in a corresponding direction, specifically about 70% to 80% in this embodiment. The length in a width direction thereof (direction orthogonal to the longitudinal direction) is shorter than the length of the liquid crystal panel 3 in a corresponding direction, preferably half the length or less, and about 10% to 20% in this embodiment. Further, the material of the light emitting diode substrate 7 is not particularly limited as long as the material is an insulating material, and the light emitting diode substrate 7 may be formed of an insulating material such as glass epoxy, paper phenol, and paper epoxy or may be formed of a metal with insulating coating. Note that, hereinafter, the longitudinal direction of the light emitting diode substrate 7, namely the direction in which the light emitting diodes 13 are arrayed, is referred to as longitudinal direction, and the direction within a plane of the light emitting diode substrate 7 and orthogonal to the longitudinal direction is referred to as width direction. Further, the above-mentioned specific dimensions of the light emitting diode substrate 7 are an example, and maybe changed as appropriate depending on design of the liquid crystal display device 1. In this embodiment, the longitudinal direction is the direction parallel to the long sides of the liquid crystal display device 1, but instead, a direction parallel to the short sides of the liquid crystal display device 1 may be the longitudinal direction.

The radiator plate 8 is a metal plate to which the light emitting diode substrate 7 is mounted and which retains the reflection sheet 6. The radiator plate 8 itself is fixed to the lower frame 9. It is preferred that the material of the radiator plate 8 be high in thermal conductivity, and various kinds of metal and alloy may be suitable for use. In this embodiment, aluminum is used. A molding method for the radiator plate 8 is not particularly limited, and any method such as pressing and cutting may be used. In this embodiment, the radiator plate 8 is obtained by an extrusion molding method.

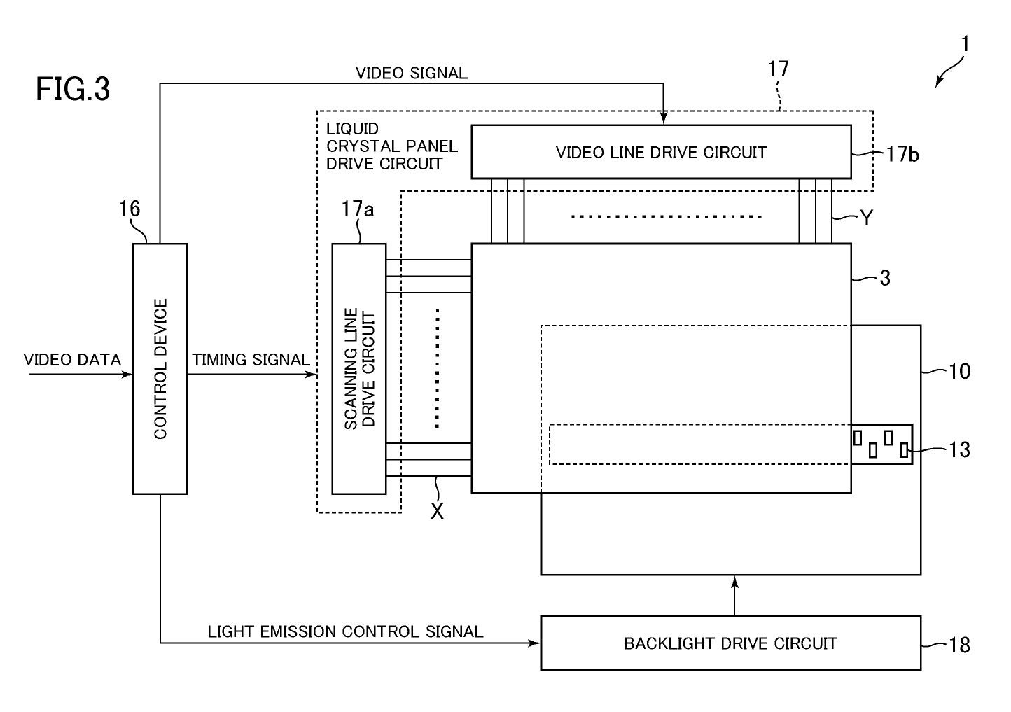

FIG. 3 is a configuration diagram illustrating a configuration of the liquid crystal display device 1. Referring to FIG. 3, functions of respective members of the liquid crystal display device 1 are described below.

The liquid crystal panel 3 has a rectangular shape, the lengths of which in the lateral direction and the vertical direction are determined depending on the intended use of the liquid crystal display device 1. The liquid crystal panel 3 may have a horizontally-elongated shape (the length in the lateral direction is longer than the length in the vertical direction) or a vertically-elongated shape (the length in the lateral direction is shorter than the length in the vertical direction). Alternatively, the lengths in the lateral direction and the vertical direction may be equal to each other. In this embodiment, the liquid crystal display device 1 is assumed to be used for a television set, and hence the liquid crystal panel 3 has a horizontally-elongated shape.

The liquid crystal panel 3 includes a pair of transparent substrates. On a TFT substrate as one of the transparent substrates, a plurality of video signal lines Y and a plurality of scanning signal lines X are formed. The video signal lines Y and the scanning signal lines X are provided orthogonal to each other to form a grid pattern. A region surrounded by adjacent two video signal lines Y and adjacent two scanning signal lines X corresponds to one pixel.

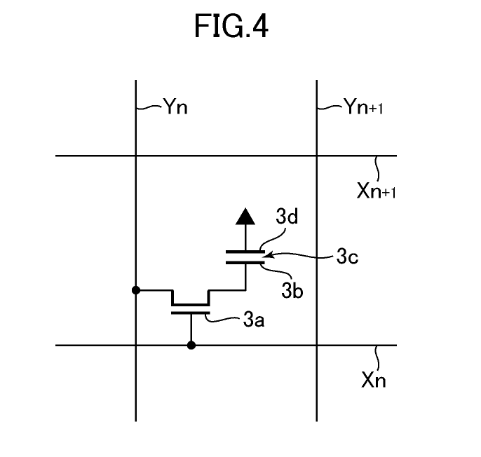

FIG. 4 illustrates a circuit diagram of one pixel formed in the liquid crystal panel 3. In FIG. 4, a region surrounded by video signal lines Yn and Yn+1 and scanning signal lines Xn and Xn+1 corresponds to one pixel. The pixel focused here is driven by the video signal line Yn and the scanning signal line Xn. On the TFT substrate side of each of the pixels, a thin film transistor (TFT) 3a is provided. The TFT 3a is turned ON by a scanning signal input from the scanning signal line Xn. The video signal line Yn applies a voltage (signal representing a gradation value for each pixel) to a pixel electrode 3b of the pixel via the ON-state TFT 3a.

On the other hand, a color filter is formed on a color filter substrate as the other of the transparent substrates and a liquid crystal 3c is sealed between the TFT substrate and the color filter substrate. Then, a common electrode 3d is formed so as to form a capacitance with the pixel electrode 3b via the liquid crystal 3c. The common electrode 3d is electrically connected to a common potential. Accordingly, depending on the voltage applied to the pixel electrode 3b, an electric field between the pixel electrode 3b and the common electrode 3d changes, thereby changing the orientation state of the liquid crystal 3c to control the polarization state of light beams passing through the liquid crystal panel 3. Polarization filters are respectively adhered to a display surface of the liquid crystal panel 3 and a rear surface thereof, which is the opposite surface of the display surface. With this, each pixel formed in the liquid crystal panel 3 functions as an element that controls light transmittance. Then, the light transmittance of each pixel is controlled in accordance with input image data, to thereby form an image. Therefore, in the liquid crystal panel 3, a region in which the pixels are formed is an image formation region.

Note that, the common electrode 3d may be provided in either the TFT substrate or the color filter substrate. How to dispose the common electrode 3d depends on the liquid crystal driving mode. For example, in an in-plane switching (IPS) mode, the common electrode 3d is provided on the TFT substrate. In a vertical alignment (VA) mode or a twisted nematic (TN) mode, the common electrode is provided on the color filter substrate. This embodiment uses the IPS mode, where the common electrode 3d is provided on the TFT substrate. Further, the transparent substrates of this embodiment are formed of glass, but other materials such as a resin may be used.

Returning to FIG. 3, into a control device 16, video data received by a tuner or an antenna (not shown) or video data generated in a different device such as a video reproducing device is input. The control device 16 may be a microcomputer including a central processing unit (CPU) and a memory such as a read only memory (ROM) and a random access memory (RAM). The control device 16 performs various types of image processing, such as color adjustment, with respect to the input video data, and generates a video signal representing a gradation value for each of the pixels. The control device 16 outputs the generated video signal to a video line drive circuit 17b. Further, the control device 16 generates, based on the input video data, a timing signal for synchronizing the video line drive circuit 17b, a scanning line drive circuit 17a, and a backlight drive circuit 18, and outputs the generated timing signal to the respective drive circuits. Note that, the present invention is not intended to limit the form of the control device 16 particularly. For example, the control device 16 may be constituted by a plurality of large scale integrations (LSIs) or a single LSI. Further, the control device 16 may not be configured to synchronize between the backlight drive circuit 18 and the other circuits.

The backlight drive circuit 18 is a circuit for supplying a current necessary for the plurality of light emitting diodes 13 which are light sources of the backlight unit 10. In this embodiment, the control device 16 generates a signal for controlling brightness of the light emitting diode 13 based on input video data, and outputs the generated signal toward the backlight drive circuit 18. Then, in accordance with the generated signal, the backlight drive circuit 18 controls an amount of current flowing through the light emitting diode and adjust the brightness of the light emitting diode 13. The brightness of the light emitting diodes 13 may be adjusted for each of the light emitting diodes 13, or the plurality of light emitting diodes 13 may be divided into some groups and the brightness may be adjusted for each of the groups. Note that, as a method of controlling the brightness of the light emitting diode 13, a pulse width modulation (PWM) method may be employed, in which the brightness is controlled based on a light emission period with a constant current amount. As an alternative method, the current amount may be set constant so as to obtain light with constant light intensity, without controlling the brightness of the light emitting diode 13.

The scanning line drive circuit 17a is connected to the scanning signal lines X formed on the TFT substrate. The scanning line drive circuit 17a selects one of the scanning signal lines X in order in response to the timing signal input from the control device 16, and the selected scanning signal line X is applied with a voltage. When the voltage is applied to the scanning signal line X, the TFTs connected to the scanning signal line X are turned ON.

The video line drive circuit 17b is connected to the video signal lines Y formed on the TFT substrate. In conformity to the selection of the scanning signal line X by the scanning line drive circuit 17a, the video line drive circuit 17b applies, to each of the TFTs provided to the selected scanning signal line X, a voltage corresponding to the video signal representing the gradation value of each of the pixels.

Note that, in this embodiment, the control device 16 and the backlight drive circuit 18 illustrated in FIG. 3 are both formed on the control board 12 of FIG. 2. Further, a liquid crystal panel drive circuit 17 constituted by the scanning line drive circuit 17a and the video line drive circuit 17b is formed on flexible printed circuits (FPCs) electrically connected to the liquid crystal panel 3 (FIG. 3), or formed on a substrate constituting the liquid crystal panel 3 (so-called system-on-glass (SOG)). Note that, the arrangement described above is an example, and the respective circuits are provided at any portions.

FIG. 5 is a view illustrating the reflection sheet 6, the light emitting diode substrate 7, and the radiator plate 8 of the liquid crystal display device 1 as viewed from the front surface side. Note that, in FIG. 5, portions of the light emitting diode substrate 7 and the radiator plate 8 which are hidden behind the reflection sheet 6 are illustrated by broken lines.

On the periphery of the reflection sheet 6, an appropriate number of fixing portions 6a protruding in a tongue shape are provided at appropriate intervals. The fixing portions 6a are used for fixing a peripheral portion of the reflection sheet 6, and in this embodiment, the fixing portions 6a are each provided with a hole for hooking therein a protrusion (not shown) provided to the intermediate frame 4 for fixation. However, the structure of fixing the peripheral portion of the reflection sheet 6 may be of any type.

Further, in a region of the center portion of the reflection sheet 6 in the width direction, holes 6b for exposing the light emitting diodes 13 to the front surface side of the reflection sheet 6 are provided corresponding to the array of the light emitting diodes 13. As illustrated in FIG. 5, the light emitting diodes 13 and the holes 6b are arrayed along the longitudinal direction. In this embodiment, the light emitting diodes 13 and the holes 6b are arrayed in two rows in the width direction, and the light emitting diodes 13 and the holes 6b belonging to different rows are arrayed in a staggered manner as illustrated in FIG. 5. Further, the array density of the light emitting diodes 13 is high around the center portion of the reflection sheet 6 in the longitudinal direction and low in the vicinity of both end portions thereof. That is, the interval between adjacent light emitting diodes 13 is larger in the peripheral portion of the image formation region than in the center portion of the image formation region. Note that, in FIG. 5, only representative one of the light emitting diodes 13 and only representative one of the holes 6b are denoted by symbols.

In this embodiment, the light emitting diode substrate 7 is divided into two at a position corresponding to the center of the image formation region, and two light emitting diode substrates 7 having the same shape are disposed at rotationally symmetric positions by one-eighty. This structure reduces the length per light emitting diode substrate 7, thus enabling the use of a compact apparatus for manufacturing the light emitting diode substrate 7 and a compact mounter for mounting the light emitting diode 13. However, dividing the light emitting diode substrate 7 is an option. The light emitting diode substrate 7 may be a single continuous substrate without being divided or may be divided into three or more substrates.

The light emitting diode substrate 7 is fixed onto the radiator plate 8, the length of which in the width direction is larger than that of the light emitting diode substrate 7. In the liquid crystal display device 1 according to this embodiment, the light emitting diodes 13 are disposed in a concentrated manner in the vicinity of the center of the liquid crystal display device 1 in the width direction. The entire image formation region is irradiated by the light emitting diodes 13 that are disposed in a concentrated manner, and hence light intensity of each light emitting diode 13 is large. Accordingly, the amount of generated heat per unit area in the region where the light emitting diodes 13 are disposed is increased. In order to dissipate the heat efficiently, the area of the radiator plate 8 having superior heat conductivity is increased to be larger than that of the light emitting diode substrate 7. The reflection sheet 6 is fixed to the radiator plate 8 by reflection sheet fixtures 19 in the vicinity of the center in the width direction.

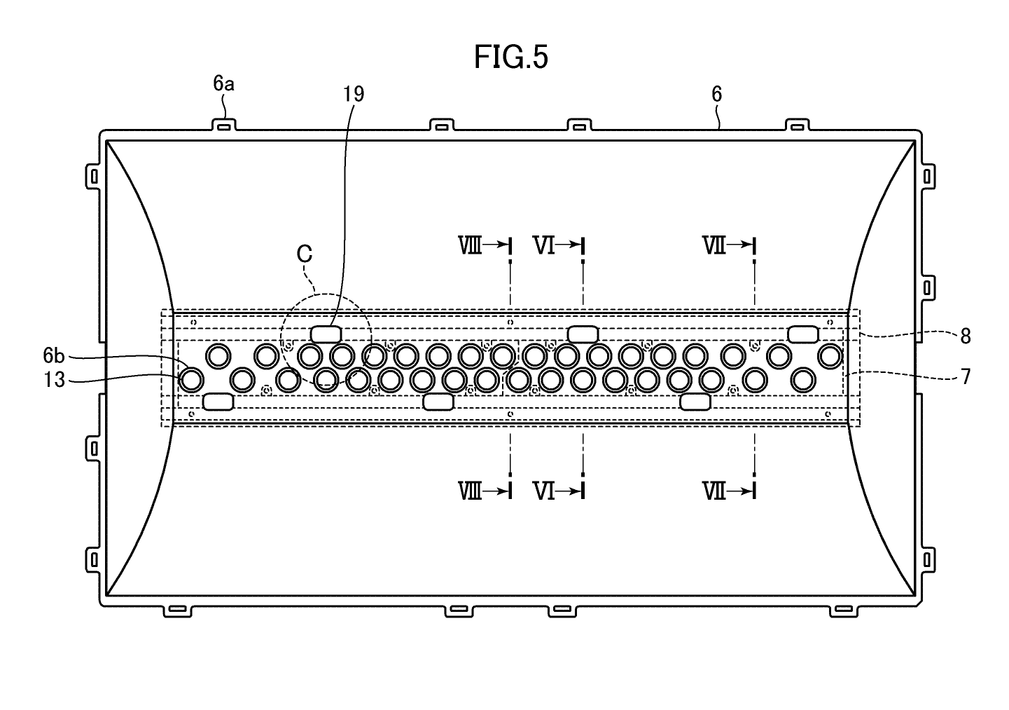

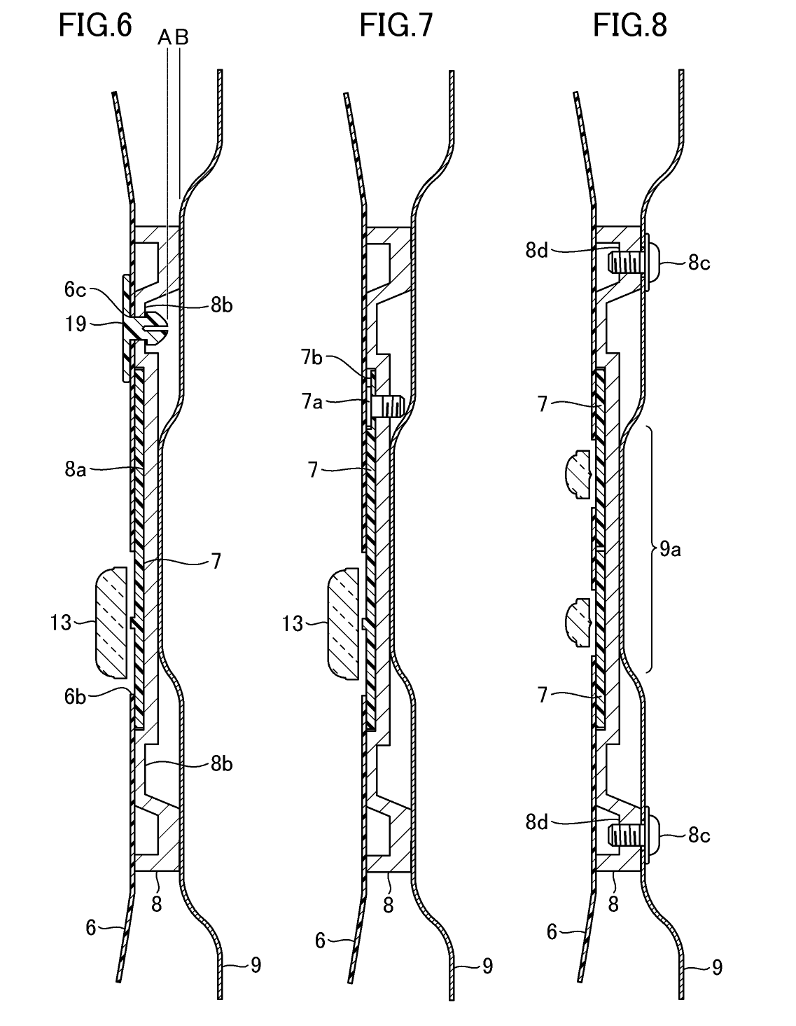

FIG. 6 is a partial enlarged cross-sectional view taken along the line VI-VI of FIG. 5. In FIG. 6, the lower frame 9 is also illustrated. The left side in FIG. 6 is the front surface side, and the right side in FIG. 6 is the rear surface side.

The radiator plate 8 includes a light emitting diode substrate receiving portion 8a, which is a recess portion formed by steps provided to the front surface thereof. The light emitting diode substrate receiving portion 8a is a recess for receiving the light emitting diode substrate 7, the length of which in the width direction is substantially the same as or slightly larger than the length of the light emitting diode substrate 7 in the width direction. Further, the depth of the light emitting diode substrate receiving portion 8a, namely the height of the steps forming the light emitting diode substrate receiving portion 8a, is substantially equal to the thickness of the light emitting diode substrate 7, preferably within ±0.5 mm with respect to the thickness of the light emitting diode substrate 7. With this, the front surface of the light emitting diode substrate 7 is substantially flush with the front surface of the radiator plate 8 on the outer side of the light emitting diode substrate 7 in the width direction.

FIG. 6 also illustrates how the light emitting diode 13 mounted on the light emitting diode substrate 7 passes through the hole 6b provided in the reflection sheet 6 and is exposed to the front surface side of the reflection sheet 6. The reflection sheet 6 is further provided with a fixing hole 6c. With the reflection sheet fixture 19 passing through the fixing hole 6c, the reflection sheet 6 is fixed to the radiator plate 8 in a region on the outer side of the light emitting diode substrate 7 in the width direction.

The size of the fixing hole 6c is slightly larger than the cross section of a passing portion of the reflection sheet fixture 19, in order to allow for a relative change in dimensions of the respective members caused by different linear expansion coefficients when the light emitting diode 13 generates heat to undergo thermal expansion. Further, the front surface of the light emitting diode substrate 7 and the front surface of the radiator plate 8 are substantially flush with each other, and hence, on the front surface side thereof, the reflection sheet 6 is retained flat without waving.

The reflection sheet fixture 19 may be of any type and is not particularly limited. In this embodiment, a fixing pin having a snap-in mechanism is used as illustrated in FIG. 6, which facilitates fixation of the reflection sheet 6. It is preferred that the material of the reflection sheet fixture 19 be the same as that of the reflection sheet 6 or be a similar white synthetic resin. This minimizes brightness unevenness at the position where the reflection sheet fixture 19 is disposed. Further, the height of a portion of the reflection sheet fixture 19 on the front surface side, namely a so-called head portion of the fixing pin, is set to be small as much as possible so that the position of the front surface of the reflection sheet fixture 19 is located on the rear surface side with respect to the position of the front surface of the light emitting diode 13. This prevents a shaded region which is not irradiated with sufficient light from the light emitting diode 13 from being formed on the outer side of the reflection sheet fixture 19 in the width direction.

The radiator plate 8 is further provided with a reflection sheet fixture receiving portion 8b which is a recess portion in the rear surface of the radiator plate 8 at the position where the reflection sheet fixture 19 is disposed. The reflection sheet fixture receiving portion 8b is a recess for receiving a portion of the reflection sheet fixture 19 exposed to the rear surface side of the radiator plate 8, namely a hook portion of the snap. Then, the position of a rear-surface side end portion of the reflection sheet fixture 19 (position indicated by A of FIG. 6) does not protrude to the rear surface side with respect to the position of a rear-surface side end portion of the radiator plate 8 (position indicated by B of FIG. 6), but positioned on the front surface side. With this, the reflection sheet fixture 19 and the lower frame 9 do not interfere with each other.

FIG. 7 is a partial enlarged cross-sectional view taken along the line VII-VII of FIG. 5. The left side in FIG. 7 is the front surface side, and the right side in FIG. 7 is the rear surface side.

As illustrated in FIG. 7, the light emitting diode substrate 7 is fixed to the radiator plate 8 by a light emitting diode substrate fixture 7a. In this embodiment, the light emitting diode substrate fixture 7a is a screw. Then, in a region in which the light emitting diode substrate fixture 7a is disposed, the front surface of the light emitting diode substrate 7 is provided with a light emitting diode substrate fixture receiving portion 7b which is a step. The light emitting diode substrate fixture receiving portion 7b receives a portion of the light emitting diode substrate fixture 7a exposed toward the front surface side of the light emitting diode substrate 7. This enables the position of the front surface of the light emitting diode substrate fixture 7a to be offset toward the rear surface side, to thereby reduce the amount by which the light emitting diode substrate fixture 7a protrudes toward the front surface side of the light emitting diode substrate 7. With this, the reflection sheet 6 is prevented from contacting the light emitting diode substrate fixture 7a and thus prevented from waving.

FIG. 8 is a partial enlarged cross-sectional view taken along the line VIII-VIII of FIG. 5. The left side in FIG. 8 is the front surface side, and the right side in FIG. 8 is the rear surface side.

As illustrated in FIG. 8, the radiator plate 8 is fixed to the lower frame 9 by a radiator plate fixture 8c. In this embodiment, the radiator plate fixture 8c is a screw. Then, in a region in which the radiator plate fixture 8c is disposed, the front surface of the radiator plate 8 is provided with a radiator plate fixture receiving portion 8d which is a recess portion. The radiator plate fixture receiving portion 8d receives a portion of the radiator plate fixture 8c exposed toward the front surface side of the radiator plate 8. With this, the positions of the front surface of the radiator plate fixture 8c is on the rear surface side of the position of the front surface of the radiator plate, and the reflection sheet 6 is prevented from contacting the radiator plate fixtures 8c and thus prevented from waving.

Further, in a region of the lower frame 9 corresponding to the light emitting diode substrate 7, a radiator plate contact portion 9a, which is a convex portion protruding toward the front surface side, is provided. The radiator plate contact portion 9a contacts the rear surface of the radiator plate 8, to thereby diffuse heat generated by the light emitting diodes 13 to the outside on the rear surface side of the lower frame 9 by heat transfer. In this embodiment, the heat is cooled by natural convection.

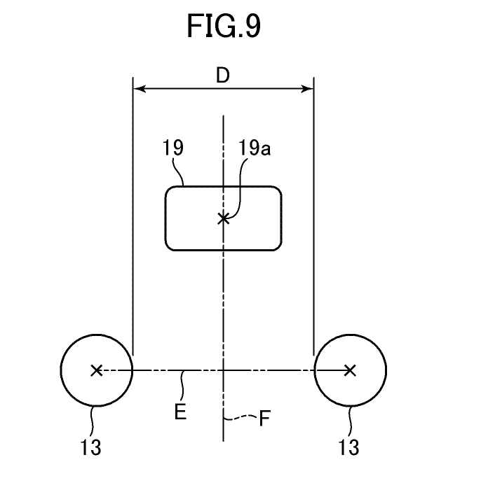

Subsequently, a positional relation between the reflection sheet fixture 19 and the light emitting diodes 13 is described. FIG. 9 is a view illustrating the positional relation between the light emitting diodes 13 and the reflection sheet fixture 19 in a region encircled by C of FIG. 5. FIG. 9 illustrates a planar positional relation between the light emitting diodes 13 and the reflection sheet fixture 19 as viewed from the front surface side. The lateral direction in FIG. 9 is the longitudinal direction, and the vertical direction in FIG. 9 is the width direction.

As described above, the head portion of the reflection sheet fixture 19 protrudes toward the front surface side from the reflection sheet 6 (see FIG. 6), and hence, if the reflection sheet fixture 19 is disposed close to the light emitting diodes 13, a shaded region which is not irradiated with sufficient light is formed in a region on the opposite side of the light emitting diodes 13 with respect to the reflection sheet fixture 19, resulting in a fear that brightness unevenness occurs. It is therefore desired to dispose the reflection sheet fixture 19 further from the light emitting diodes 13 as much as possible in design. In view of the above, in this embodiment, the position of the reflection sheet fixture 19 in the longitudinal direction is shifted from the position of the light emitting diode 13 in the longitudinal direction so that the position of the reflection sheet fixture 19 and the position of the light emitting diode 13 do not overlap each other in the width direction. To be exact, a center position 19a of the reflection sheet fixture 19 in the longitudinal direction is in a range between two light emitting diodes 13 in the longitudinal direction that are positioned close to the reflection sheet fixture 19. The range between two light emitting diodes 13 in the longitudinal direction is a range indicated by D of FIG. 9, and refers to a range between near ends of the two light emitting diodes in the longitudinal direction. Further, the arrangement in which the reflection sheet fixture 19 is furthest from the light emitting diodes 13 is such that the center position 19a of the reflection sheet fixture 19 is disposed on a perpendicular bisector F to a segment E connecting the centers of two light emitting diodes 13 that are present close to the reflection sheet fixture 19. In this embodiment, the reflection sheet fixture 19 is disposed as described above.

Note that, the embodiment described above is a specific example for describing the present invention, and the present invention is not intended to be limited to the embodiment.

For example, in the embodiment, the light emitting diode 13 includes the lens, but the lens is not always necessary when light emitted from the light emitting diode element diffuses sufficiently. Further, in the embodiment, the liquid crystal display device 1 is structured to have only a single light emitting diode substrate 7 at the center of the liquid crystal display device 1 in the width direction, but maybe structured to have two or more light emitting diode substrates 7 which are disposed side by side in the width direction thereof. Still further, the number and arrangement of the light emitting diodes 13 and the number, shape, and arrangement of other members are not limited to the ones described in the embodiment, and an appropriate number, shape, and arrangement are intended to be optimized as necessary.

In other words, while there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device, comprising:
a liquid crystal panel; and
a backlight unit comprising in order from the liquid crystal panel side:
a reflection sheet, which is disposed on a rear surface side of the liquid crystal panel and is curved so as to have a concave surface facing the liquid crystal panel;
a light emitting diode substrate on which a plurality of light emitting diodes are disposed along a longitudinal direction; and
a metal plate to which the light emitting diode substrate is fixed,
wherein a length of the metal plate in a width direction is larger than a length of the light emitting diode substrate in the width direction.

2. The liquid crystal display device according to claim 1, wherein the metal plate comprises, in a front surface thereof, a light emitting diode substrate receiving portion for receiving the light emitting diode substrate.

3. The liquid crystal display device according to claim 1, wherein the reflection sheet is fixed to the metal plate by a reflection sheet fixture in a region on an outer side of the light emitting diode substrate in the width direction.

4. The liquid crystal display device according to claim 3, wherein the metal plate comprises, in a rear surface thereof, a reflection sheet fixture receiving portion for receiving a portion of the reflection sheet fixture exposed to the rear surface side of the metal plate.

5. The liquid crystal display device according to claim 1, wherein:
the light emitting diode substrate is fixed to the metal plate by a light emitting diode substrate fixture; and
the light emitting diode substrate comprises a light emitting diode substrate fixture receiving portion for receiving a portion of the light emitting diode substrate fixture exposed to a front surface side of the light emitting diode substrate.

6. The liquid crystal display device according to claim 1, wherein:
the metal plate is fixed to a housing for receiving the liquid crystal panel and the backlight unit by a metal plate fixture; and
the metal plate comprises, in a front surface thereof, a metal plate fixture receiving portion for receiving a portion of the metal plate fixture exposed to the front surface side of the metal plate.

7. The liquid crystal display device according to claim 3, wherein a center position of the reflection sheet fixture in the longitudinal direction is in a range between two of the plurality of light emitting diodes in the longitudinal direction that are positioned close to the reflection sheet fixture.

8. The liquid crystal display device according to claim 7, wherein the center position of the reflection sheet fixture is disposed on a perpendicular bisector to a segment connecting centers of the two of the plurality of light emitting diodes that are positioned close to the reflection sheet fixture.
